(19) United States
(12) Patent Application Publication
(10) Pub. No.: US 2022/0410226 A1
(43) Pub. Date: Dec. 29, 2022

(54) DEVICE AND PROCESS FOR EFFECTUATING SLASH-CUTTING OF USED CHEMICAL JUGS

(71) Applicant: Paul Thomas Hitchens, Hessel, MI (US)

(72) Inventor: Paul Thomas Hitchens, Hessel, MI (US)

(21) Appl. No.: 17/846,192

(22) Filed: Jun. 22, 2022

Related U.S. Application Data
(60) Provisional application No. 63/213,828, filed on Jun. 23, 2021.

(51) Int. Cl. B08B 9/093; B26F 1/24

(52) U.S. Cl. CPC B08B 9/093; B26F 1/24; B08B 2209/08

(57) ABSTRACT

A device and process for cleaning and decommissioning used chemical jugs or containers of any size, including an upper positioned clean water manifold which feeds a pressurized inlet fluid to a vertically downwardly arrayed elongated and spike shaped component having a sharpened lower end, the spike shape component being downwardly actuated for successively piercing at least one wall of the container. The hollow spike shaped component also includes a plurality of laterally and/or angularly positioned pressurized fluid outlets for issuing fluid evenly across the inside surface area of the jug for subsequent drainage through a pierced bottom of the jug.

### CROSS REFERENCE TO RELATED APPLICATIONS

The present application claims the priority of U.S. Ser. No. 63/213,828 filed Jun. 23, 2021.

### FIELD OF THE INVENTION

The present invention relates generally to container cleaning and washing techniques. More particularly, the present invention discloses a device and process for cleaning and decommissioning used chemical jugs or containers of any size, such utilizing an upper positioned clean water manifold which feeds a pressurized inlet fluid to a vertically downwardly arrayed elongated and spike shaped component having a sharpened lower end for successively piercing at least one wall of the container is positioned upright and, more typically, each of upper and lower walls of a sideways positioned container upon an underneath located support platen. The hollow spike shaped component also includes laterally and/or angularly positioned pressurized fluid outlets for issuing fluid evenly across the inside surface area of the jug. An additional feature of the hollow spike component is the provision of an intermediately positioned and axially adjustable interior plug, the purpose for which is to adjust to a proximate bottom interior wall location of the jug to vary the vertical range of the interior fluid flow patterns to accommodate jugs of varying dimension and to prevent waste of the pressurized spray.

### BACKGROUND OF THE INVENTION

The prior art is documented with numerous examples of jug cleaning and washing assemblies. One common practice is to insert a conventional hose into the jug interior and prior to dumping the contents into the spray tank.

An example of a chemical jug washer and disposal assembly is disclosed in US 2016/0303624 and related U.S. Pat. No. 10,603,699, to Hitchens, which teaches a combination cleaning and disposal assembly for safely cleaning and rendering unusable a jug containing a hazardous chemical residue. A body supports a receiving chamber for receiving the jug. A manifold is supported by the body and has a plurality of spikes arrayed toward the jug. A pressurized fluid source is communicated to the manifold such that, upon an inter-displacement occurs between the manifold and the container, the spikes are caused to pierce the container, the pressurized fluid being caused to issue from the spikes to clean an interior of the container. A drain is located underneath the jug receiving chamber which collects and segregates the fluid contaminated with the chemical residue for securing disposal concurrent with removing and disposing of the now-cleaned and punctured jug.

### SUMMARY OF THE PRESENT INVENTION

The present invention discloses a device and process for cleaning and decommissioning used chemical jugs or containers of any size, including an upper positioned clean water manifold which feeds a pressurized inlet fluid to a vertically downwardly arrayed elongated and spike shaped component having a sharpened lower end, the spike shape component being downwardly actuated for successively piercing at least one wall of the container. The hollow spike shaped component also includes a plurality of laterally and/or angularly positioned pressurized fluid outlets for issuing fluid evenly across the inside surface area of the jug for subsequent drainage through a pierced bottom of the jug.

A platen is located underneath the spike component and includes at least one drainage aperture aligning with the sharpened lower end. An intermediately positioned and axially adjustable interior plug is located within the hollow interior of the spike component, the plug being axially adjustable to a proximate bottom interior wall location of the jug to vary the vertical range of the interior fluid flow patterns to accommodate jugs of varying dimension and to prevent waste of the pressurized spray.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is plan cutaway view of a slash cut cleaning and decommissioning device and process according to a non-limiting variant of the present invention and including an upper positioned clean water manifold which feeds a pressurized inlet fluid to a vertically downwardly arrayed elongated and spike shaped component having a sharpened lower end for successively piercing at least one wall of the container is positioned upright and, more typically, each of upper and lower walls of a sideways positioned container upon an underneath located support platen, the hollow spike shaped component also including laterally and/or angularly positioned pressurized fluid outlets for issuing fluid evenly across the inside surface area of the jug, with an additional feature of the hollow spike component including the provision of an intermediately positioned and axially adjustable interior plug, the purpose for which is to adjust to a proximate bottom interior wall location of the jug to vary the vertical range of the interior fluid flow patterns to accommodate jugs of varying dimension and to prevent waste of the pressurized spray.

### DETAILED DESCRIPTION OF THE PREFERRED EMBODIMENTS

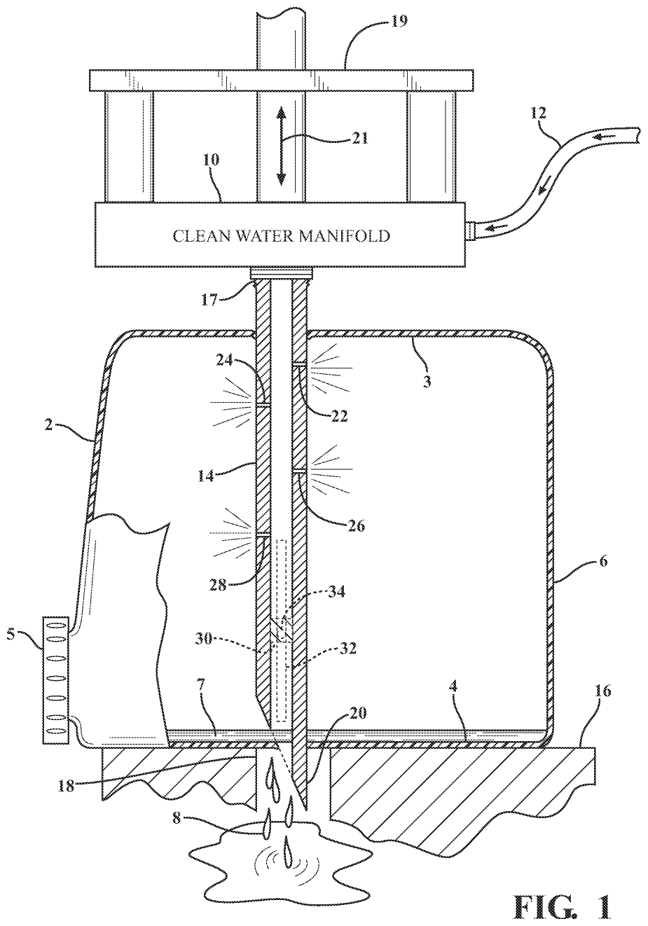

With reference to the attached illustrations, and notably to FIG. 1, the present invention discloses a device and process for cleaning and decommissioning used chemical jugs or containers of any size, such including an upper positioned clean water manifold 10 which feeds a pressurized inlet fluid via a suitable conduit 12 to a vertically downwardly arrayed elongated and spike shaped component 14. As shown, the spike shaped component 14 is secured to the overhead manifold 10 through the use of any suitable coupling or fitting 17 and, depending upon the variant employed, can be vertically actuated or displaced using any known mechanism, such as is further generally represented at 19 and can include (without limitation) a numerically actuated and piston or servo controlled device displace-able between an upper most and non-use position (not shown) and a lowermost descending and puncturing position (shown), this further depicted by a bi-directional arrow 21.

The spike shaped component 14 can be constructed of a durable and rust-resistant metal (such as stainless steel or aluminum) or can be constructed from an impact resistant polymer. In any instance, the spike component 14 is interiorly hollowed and includes a sharpened lower end which, upon downwardly actuating, successively pierces at least one wall of a used jug or container (see at 2) container.

As further shown, the container/jug 2 can be positioned sideways upon an underneath located support platen 16 (such further having an alignment aperture 18 for receiving and seating a downwardly descending and puncturing tip 20 of the spike component 14), through each of upper 3 and lower 4 walls of a sideways positioned container upon the underneath located support platen 16. Without limitation, the container or jug 2 can also be repositioned in an upright manner and so that the spike 14 can pass through a top wall of the container or in alignment with a top fill opening upon removal of a cap 5, with the spike tip 20 subsequently piercing through a bottom interconnecting wall 6 of the jug/container 2.

The hollow spike shaped component 14 also includes a plurality of laterally and/or angularly positioned pressurized fluid outlets or nozzles 22, 24, 26, 28, et seq., for issuing the pressurized fluid (such as water or water mixed with a cleaning agent) evenly across the inside surface area of the jug or container 2. Also disclosed is an intermediately positioned and axially adjustable interior plug 30 frictionally engaged within the interior annular wall of the spike shaped and interiorly hollowed component 14 in order to prevent pressurized fluid delivered from the manifold into the upper end of the spike component 14 from passing between the plug and the opposing inside annular surface of the spike interior wall.

The plug 30 in this fashion can be frictionally adjustable in up and down fashion along an interior track 32 in order to adjust the plug relative to a proximate bottom interior wall 4 location of the jug or container 2, this in order to vary a vertical range of the interior fluid flow patterns issued from the outlets or nozzles 22-28 to accommodate jugs of varying dimension and to prevent waste of the pressurized spray from issuing outside of the container interior. The plug 30 can also be keyed or otherwise supported within the interior track (see again in phantom at 32) via a pin or other locating portion (at 34) for seating in the track to permit adjustment of the plug to define a desired overall interior range of spray profile and to selectively be adjusted upwardly to block any one or more of the lowermost sideways positioned spray nozzles to accommodate smaller sized jugs 2.

As further shown, and upon washing the interior of the jug or container, a volume of the fluid (see at 7) collects on the bottom of the jug interior and drains through bottom location 8 which can include the platen aperture 18 through which the pointed/puncturing tip 20 of the piercing spike 14 travels in order to communicating the bottom pierced wall 4 of the jug/container with the platen aperture 18. To this end, the spike 14 can also be partially retracted following initial downward actuation in order to size the inner annular rim formed with the bottom wall 4 and the flared piercing end 20 of the spike in order to facilitate drainage of the fluid. Without limitation, the platen or support can additionally or alternatively be apertured or grated to provide for more even drainage of contaminated/dirty fluid from the jug interior, such as which can be either drained or collected in a separate reservoir for disposal.

Having described my invention, other and additional preferred embodiments will become apparent to those skilled in the art to which it pertains, and without deviating from the scope of the appended claims. This can include envisioned variants in which multiple washing stations, each with a separate upright supported spray tube, is provided along with a common or individual segregated chambers in order to wash multiple chemical containers prior to either of disposal or reuse.

The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit, the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A device and process for cleaning and decommissioning used chemical jugs or containers of any size, comprising:
an upper positioned clean water manifold which feeds a pressurized inlet fluid to a vertically downwardly arrayed elongated and spike shaped component having a sharpened lower end, said spike shape component being downwardly actuated for successively piercing at least one wall of the container; and
said hollow spike shaped component also including a plurality of laterally and/or angularly positioned pressurized fluid outlets for issuing fluid evenly across the inside surface area of the jug for subsequent drainage through a pierced bottom of the jug.

2. The device and process of claim 1, further comprising a platen located underneath said spike component, said platen including at least one drainage aperture aligning with the sharpened lower end.

3. The device and process of claim 1, further comprising an intermediately positioned and axially adjustable interior plug located within the hollow interior of the spike component, said plug being axially adjustable to a proximate bottom interior wall location of the jug to vary the vertical range of the interior fluid flow patterns to accommodate jugs of varying dimension and to prevent waste of the pressurized spray.

4. A device and process for cleaning and decommissioning used chemical jugs or containers of any size, comprising:
an upper positioned clean water manifold which feeds a pressurized inlet fluid to a vertically downwardly arrayed elongated and spike shaped component having a sharpened lower end, said spike shape component being downwardly actuated for successively piercing at least one wall of the container;
said hollow spike shaped component also including a plurality of laterally and/or angularly positioned pressurized fluid outlets for issuing fluid evenly across the inside surface area of the jug for subsequent drainage through a pierced bottom of the jug; and
an intermediately positioned and axially adjustable interior plug located within the hollow interior of the spike component, said plug being axially adjustable to a proximate bottom interior wall location of the jug to vary the vertical range of the interior fluid flow patterns to accommodate jugs of varying dimension and to prevent waste of the pressurized spray.

5. The device and process of claim 4, further comprising a platen located underneath said spike component, said platen including at least one drainage aperture aligning with the sharpened lower end.
